(19) United States
(12) Patent Application Publication
(10) Pub. No.: US 2001/0053007 A1
(43) Pub. Date: Dec. 20, 2001

(54) Optical pulse period compressing apparatus and method

(76) Inventor: Makoto Shikata, Yokohama (JP)

Correspondence Address: VENABLE, Post Office Box 34385, Washington, DC, 20043-9998, US

(21) Appl. No.: 09/788,522

(22) Filed: Feb. 21, 2001

(30) Foreign Application Priority Data
Jun. 14, 2000 (JP) 2000-178303

(51) Int. Cl. H04J 14/08

(52) U.S. Cl. 359/140; 359/135

(57) ABSTRACT

A method and apparatus is described for compressing an optical pulse period of an optical pulse signal. The apparatus comprises at least one optical circuit each including optical delay means for delaying an-input optical signal to generate a first delayed optical signal, optical guiding means for guiding the first delayed optical signal to the optical delay means, and optical coupling means for coupling optical signals. The optical delay means delays the first delayed optical signal to generate a second delayed optical signal. The optical coupling means couples the second delayed optical signal with the input optical signal.

### BACKGROUND OF THE INVENTION

1. Field of the Invention

The present invention relates to a method and apparatus for compressing a pulse period of an optical pulse signal.

2. Description of the Related Art

In recent years, the realization of a broad-band transmission path has been required in association with an increase in communication demands such as local area networks (LAN) or the like. Research and development is being actively pursued relating to an optical communication network using a time-division multiplexing (TDM) technique for multiplexing and demultiplexing an optical signal on a time base, since the optical communication network has an extremely large transmission capacity. An optical pulse period modulating technique for compressing and expanding a pulse period of an optical pulse signal is indispensable in order to realize the TDM network.

There is disclosed an optical pulse period compressing apparatus for compressing an optical pulse period, for example, in “A 1024-Channel Fast Tunable Delay Line for Ultrafast All-Optical TDM Networks”, Kung-Li Deng, Koo Il Kang, Ivan Glask, and Paul Prucnal, IEEE Photonics Technology Letters, pp. 1496-1498, Vol. 9, No. 11, November 1997.

FIG. 1 shows an example of a configuration of the optical pulse period compressing apparatus. There is provided a cascaded k-stages delay structure in the optical pulse period compressing apparatus. Each delay stage has an optical delay circuit Dⱼ (j=1 to k). The compressing apparatus is configured to compress an optical pulse period of an optical pulse signal (or optical clock signal) P_{IN} supplied to the apparatus into ½^{k}. For example, in case of an optical pulse period compressing apparatus having a delay structure of three stages, as shown in FIG. 2, an optical output signal (S3) of the third delay stage becomes an optical pulse period of ⅛ of that of the input optical pulse signal (P_{IN}) The output optical signal S3 has a frequency of eight times. The optical pulse signal compressed as mentioned above is extracted as a packet signal of every eight bits at a period of every eight pulses of the input optical pulse signal by using an optical switch (SW), so that an optical packet signal (P_{OUT}) can be obtained.

### OBJECTS AND SUMMARY OF THE INVENTION

In the conventional optical pulse period compressing apparatus, however, there is a problem such that a size of optical delay increases when a compression ratio is large since a pulse period after compression is determined by a delay time of the optical delay device.

The present invention is made in consideration of the above problem and it is an object of the invention to provide an optical pulse period compressing apparatus which can be made small-sized and of high performance.

According to the present invention, there is provided an optical pulse period compressing apparatus for compressing an optical pulse period of an optical pulse signal, which comprises at least one optical circuit each including optical delay means for delaying an input optical signal to generate a first delayed optical signal, optical guiding means for guiding the first delayed optical signal to the optical delay means, and optical coupling means for coupling optical signals; wherein the optical delay means delays the first delayed optical signal to generate a second delayed optical signal, and the optical coupling means couples the second delayed optical signal with the input optical signal.

According to the present invention, there is provided an optical apparatus for compressing an optical pulse period of an optical pulse signal, which comprises optical delay means for delaying an input optical signal to generate a first delayed optical signal; optical guiding means for guiding the first delayed optical signal to the optical delay means; and optical coupling means for coupling optical signals, wherein the optical delay means delays the first delayed optical signal to generate a second delayed optical signal, and the optical coupling means couples the second delayed optical signal with the input optical signal.

According to the present invention, there is provided a method for compressing a pulse period of an optical pulse signal of an optical apparatus having optical delay means, which comprises the steps of delaying the optical pulse signal to generate a first delayed optical signal in the optical delay means; guiding the first delayed optical signal to the optical delay means; delaying the first delayed optical signal to generate a second delayed optical signal in the optical delay means; and coupling the second delayed optical signal with the optical pulse signal.

### BRIEF DESCRIPTION OF THE DRAWINGS

FIG. 1 is a block diagram schematically showing an example of a configuration of a conventional optical pulse period compressing apparatus;

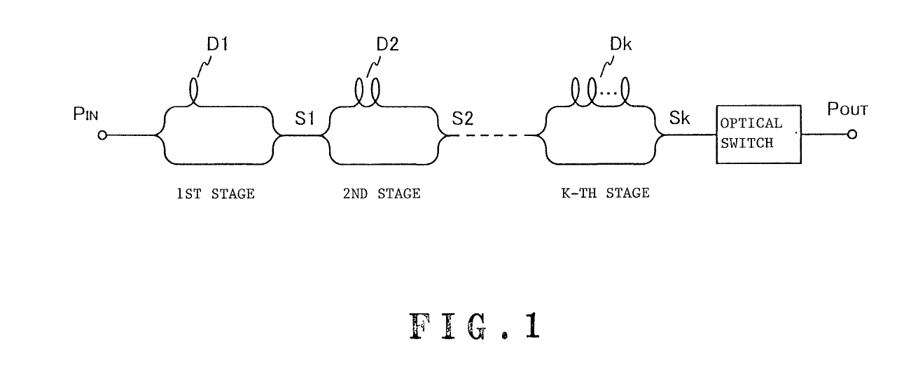

FIG. 2 is a block diagram showing a configuration of an optical pulse period compressing apparatus according to the first embodiment of the present invention;

FIG. 3 is a time chart for illustrating the operation of the optical pulse period compressing apparatus shown in FIG. 2;

FIG. 4 is a block diagram showing a configuration of an optical pulse period compressing apparatus according to the second embodiment of the present invention; and

FIG. 5 is a time chart for illustrating the operation of the optical pulse period compressing apparatus shown in FIG. 4.

### DETAILED DESCRIPTION OF THE PREFERRED EMBODIMENTS

Embodiments of the present invention will now be described in detail hereinbelow with reference to the drawings. In the diagrams which are used in the following description, substantially equivalent component elements are designated by the same reference numerals.

### First Embodiment

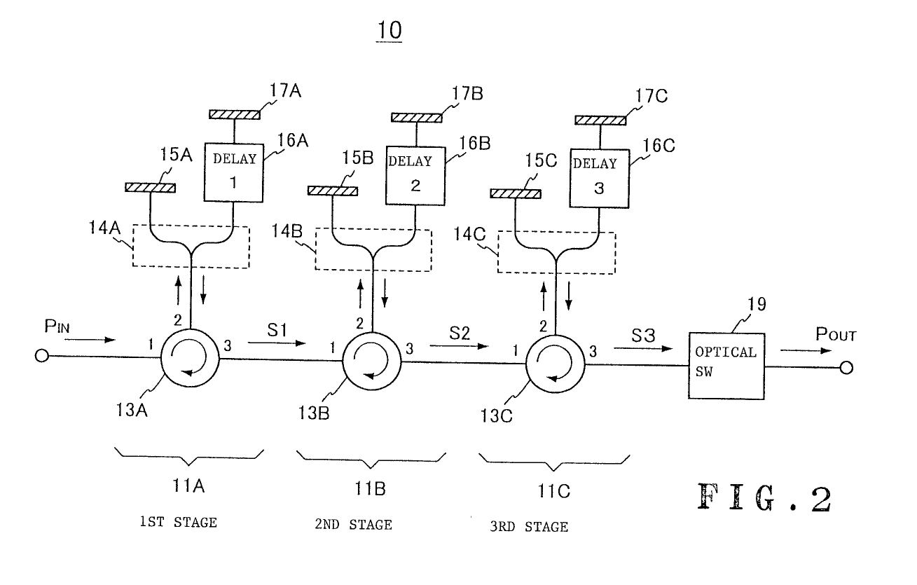

FIG. 2 is a block diagram showing a configuration of an optical pulse period compressing apparatus 10 according to the first embodiment of the present invention.

The optical pulse period compressing apparatus 10 includes optical circuits 11A, 11B, and 11C of three stages which are cascade connected and an optical switch 19. The optical circuit 11A of the first stage includes an optical circulator 13A, a branching/coupling device (optical coupler) 14A, total reflection optical terminators 15A and 17A, and a first optical delay unit 16A. Each of the optical circuits 11B and 11C of the second and third stages has a configuration similar to that of the optical circuit 11A of the first stage except for a delay amount of the optical delay unit.

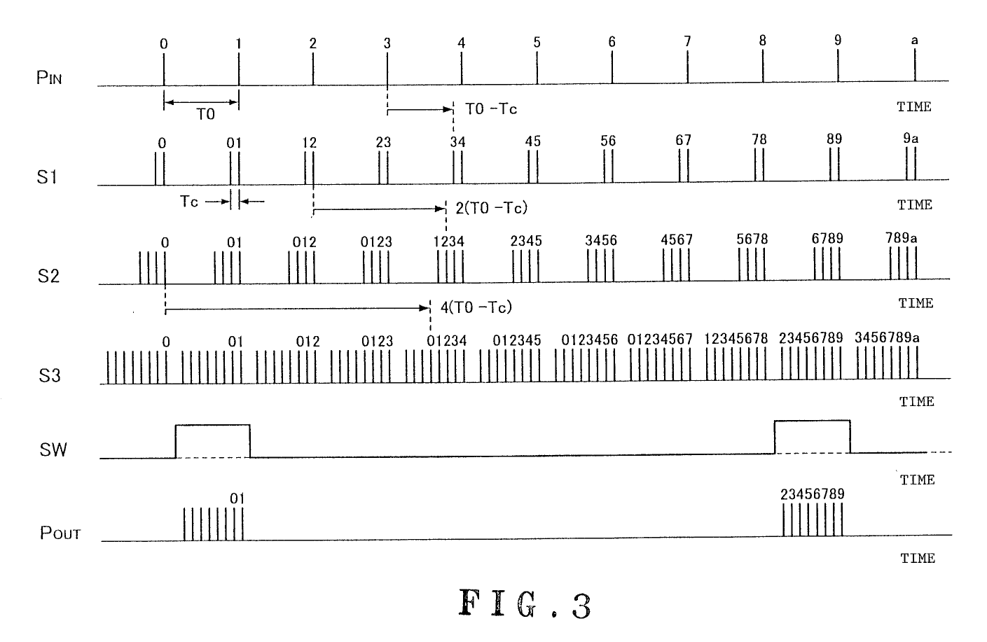

An optical pulse signal (P_{IN}) is supplied to an optical input terminal of the optical pulse period compressing apparatus 10. As shown in FIG. 3, the input optical pulse signal P_{IN} is an intensity modulated optical pulse signal (binary signal) having a predetermined pulse period (bit period) T0 and the pulse width is smaller than an optical pulse period Tc after compression, which will be described hereinlater.

In the optical circuit 11A of the first stage, the input optical pulse signal P_{IN} to a first port of the optical circulator 13A is circulated or routed to a second port and supplied to the optical coupler 14A. The optical pulse signal P_{IN} is separated into two optical pulse signals having almost the same light intensity in the optical coupler 14A. In other words, the optical coupler 14A is one of a 3 dB photocoupler. One of the separated optical pulse signals is totally reflected by the first total reflection optical terminator 15A and returned to the optical coupler 14A. The other optical signal is delayed by the optical delay unit 16A. The delayed optical signal is, then, guided or returned to the optical delay unit 16A. More particularly, the delayed optical signal is totally reflected by the second total reflection optical terminator 17A and returned to the optical delay unit 16A. The delayed optical signal is delayed again by the optical delay unit 16A, and returned to the optical coupler 14A. The optical delay unit 16A has a delay time D/2=(T0−Tc)/2 and can delay the other one of the separated optical pulse signals by a delay time D=T0−Tc due to the delay which is caused by the reciprocation. Here, Tc denotes the optical pulse period after completion of the optical pulse period.

The optical pulse signal delayed by the delay amount D is coupled with the optical pulse signal which is totally reflected by the first total reflection optical terminator 15A in the optical coupler 14. More particularly, as shown in FIG. 3, the optical circuit 11A couples the optical pulse signal delayed by the delay time D in the optical delay unit 16A with the optical pulse signal without a delay, thereby compressing the optical pulse period. An optical pulse signal (S1) obtained by the coupling is an optical signal in which an optical pulse train including two optical pulses, of which optical pulse period are equal to Tc, is periodically repeated. The period of the optical pulse train is equal to T0. The optical pulse signal S1 obtained by the coupling is supplied to the second port of the optical circulator 13A and routed to a third port of the optical circulator 13A.

The output optical pulse signal S1 from the optical circuit 11A is supplied to the optical circuit 11B of the next stage. An optical delay unit 16B of the optical circuit 11B has a delay amount D (delay time D=T0−Tc) that is twice as large as that of the optical delay unit 16A in the optical circuit 11A. In a manner similar to the case of the optical circuit 11A, as shown in FIG. 3, an optical pulse signal S2 is obtained by coupling the optical pulse signal delayed by a delay time 2D (=2(T0−Tc)) and the optical pulse signal without a delay. The optical pulse signal S2 is an optical signal in which an optical pulse train including four optical pulses, whose optical pulse periods are equal to Tc, is repeated with a period T0.

The optical pulse signal S2 is supplied to the optical circuit 11C of the third stage through a third port of an optical circulator 13B. An optical delay unit 16C of the optical circuit 11C has a delay amount 2D (delay time 2D=2(T0−Tc)) which is twice as large as that of the optical delay unit 16B in the optical circuit 11B of the second stage. As shown in FIG. 3, therefore, the optical pulse signal S3 is obtained by coupling the optical pulse signal delayed by a delay time 4D (=4(T0−Tc)) and the optical pulse signal without a delay. The optical pulse signal S3 is an optical signal in which an optical pulse train including eight optical pulses whose optical pulse periods are equal to Tc is periodically repeated. A period of the optical pulse train is set to T0.

The optical pulse period compression signal obtained by the cascade-connected optical circuits 11A to 11C of the first to the third stages, i.e., the optical pulse signal S3 is supplied to the optical switch 19. The optical switch 19 extracts the optical pulse train including eight optical pulses from the optical pulse signal S3 at a period (=8T0) which is eight times as long as the period T0 of the input optical pulse signal P_{IN} to the optical pulse period compressing apparatus 10 as shown in FIG. 3. The extracted optical signal P_{OUT} is, therefore, an optical packet signal which includes eight optical pulses whose optical pulse periods are equal to Tc and whose optical packet period is equal to 8T0. In other words, the optical pulse period compressing apparatus 10 compresses the input optical pulse signal at the optical pulse period every 8 bits.

As an optical switch 19, an optical switch which operates in response to an extraction signal from an external circuit can be also used, or the optical switch can also have a circuit for generating the extraction signal therein.

The apparatus according to the present invention includes the reflecting means for reflecting the delayed optical pulse signal and the delay means for delaying the optical pulse signal reflected by the reflecting means (i.e., delaying the signal on the reciprocating paths) as mentioned above. Thus, the delay amount necessary for the delay means can be reduced to ½. The optical pulse period compressing apparatus having a small-sized optical delay unit, therefore, can be realized.

Although the case of the optical pulse period-compressing apparatus for compressing the optical pulse period every eight bits has been shown as an example in the embodiment, an optical pulse period compressing apparatus of 2*n bits can be constructed by connecting optical circuits of n-stages in a cascade form.

A variable optical delay device of a delay amount which is variable can be also used as the optical delay unit. Various kinds of optical switches can be used as the optical switch 19. For example, an optical switch having an electro-absorption semiconductor optical modulator, a Mach-Zehnder optical modulator, or the like can be used.

### Second Embodiment

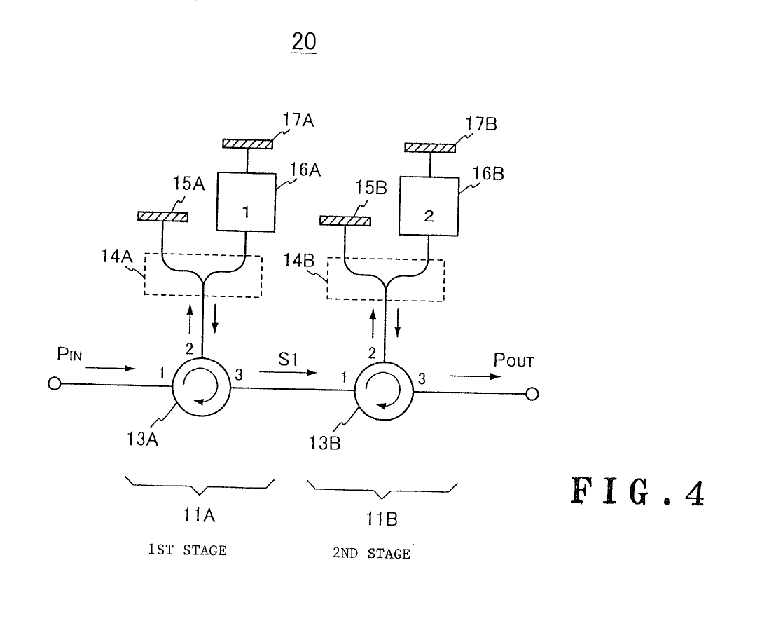

FIG. 4 is a block diagram showing a configuration of an optical pulse period compressing apparatus 20 according to the second embodiment of the present invention. The optical pulse period compressing apparatus 20 is an apparatus for compressing an optical pulse period of an input optical pulse signal to ¼ and constructed by the cascade-connected optical circuits 11A and 11B of two stages.

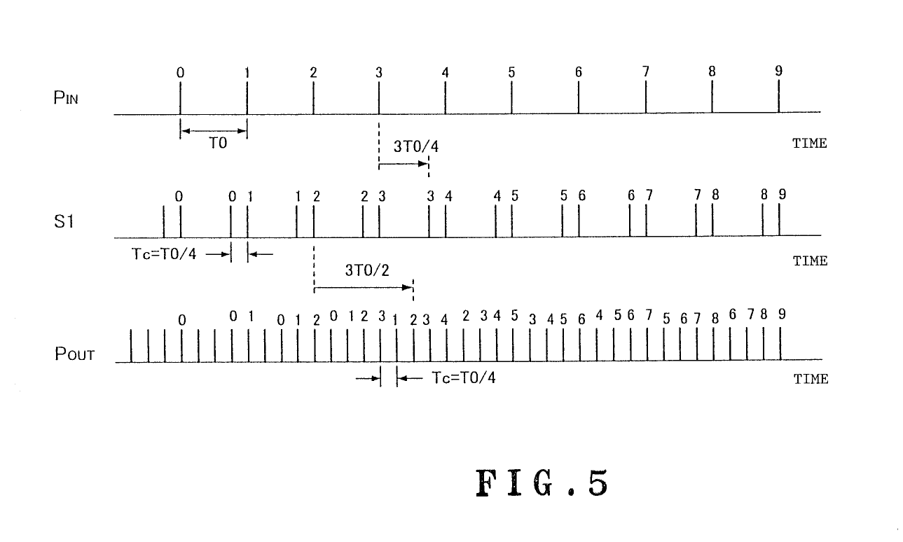

An optical pulse signal (P_{IN}) is supplied to an optical input terminal of the optical pulse period compressing apparatus 20. The input optical pulse signal P_{IN} is an intensity modulated optical pulse signal (binary signal) having a predetermined pulse period (bit period) T0 as shown in FIG. 5.

The input optical pulse signal P_{IN} is supplied to the optical circuit 11A of the first stage. The optical circuit 11A has the optical delay unit 16A having a delay time of D/2. To compress the optical pulse period of the input optical pulse signal into ¼ (i.e., to increase a frequency of the optical pulse by four times), the delay time D is predetermined so as to satisfy D=3T0/4. More particularly, the delay time of the optical pulse signal by the optical delay unit 16A is equal to D/2=3T0/8. As shown in FIG. 5, therefore, the optical circuit 11A compresses the optical pulse period by coupling the optical pulse signal without a delay and the optical pulse signal delayed by the delay time D (=3T0/4) in the optical delay unit 16A of a delay time which is equal to D/2. The optical pulse signal (S1) obtained by the coupling is an optical signal in which an optical pulse train including two optical pulses, whose optical pulse periods are equal to T0/4, is repeated with the period T0. The optical pulse signal S1 is supplied to the second port of the optical circulator 13A and routed to the third port of the optical circulator 13A.

The output optical pulse signal S1 of the optical circuit 11A is supplied to the optical circuit 11B of the next stage. The optical delay unit 16B of the optical circuit 11B has a delay amount (delay time D=3T0/4) which is twice as large as that of the optical delay unit 16A in the optical circuit 11A. In a manner similar to the case of the optical circuit 11A, the optical pulse signal P_{OUT} is obtained by coupling the optical pulse signal delayed by the delay time 2D (=3T0/2) and the optical pulse signal without a delay as shown in FIG. 5. The optical pulse signal P_{OUT} is an optical pulse signal having a constant optical pulse period (namely, T0/4).

As mentioned above, the apparatus has a guiding means for guiding the delayed optical signal delayed by a delay means to the delay means. The delayed optical signal is delayed again in the delay means, so that the delay amount necessary for the optical delay means can be reduced.

The number of stages of the optical circuits, the delay amount of the delay unit, the number of bits of the optical pulse signal, and the like described in the embodiments are shown as examples and can be also varied. The various embodiments are shown as examples and a proper combination thereof or modifications are also possible.

As will be obviously understood from the above description, according to the present invention, the optical pulse period compressing apparatus having a small-sized optical delay unit is realized since the delay amount necessary for the optical delay unit can be reduced.

The invention has been described with reference to the preferred embodiments thereof. It should be understood by those skilled in the art that a variety of alterations and modifications may be made from the embodiments described above. It is therefore contemplated that the appended claims encompass all such alternations and modifications.

What is claimed is:

1. An optical pulse period compressing apparatus for compressing an optical pulse period of an optical pulse signal, comprising:
at least one optical circuit each including optical delay means for delaying an input optical signal to generate a first delayed optical signal, optical guiding means for guiding said first delayed optical signal to said optical delay means, and optical coupling means for coupling optical signals;
wherein said optical delay means delays the first delayed optical signal to generate a second delayed optical signal, and said optical coupling means couples said second delayed optical signal with said input optical signal.

2. An apparatus according to claim 1, wherein the optical circuits are connected in a cascade manner.

3. An apparatus according to claim 1, further comprising extracting means for extracting an optical pulse train including a predetermined number of optical pulses from an optical signal generated in said optical coupling means at a predetermined period.

4. An apparatus according to claim 1, wherein the optical signal generated in said optical coupling means has a predetermined optical pulse period.

5. An apparatus according to claim 1, wherein said optical delay means is configured such that delay amount of said optical delay means can be varied.

6. An apparatus according to claim 2, wherein said optical circuit includes an optical circulator for guiding an input optical pulse signal to said optical delay means and guiding the optical pulse signal generated in said optical coupling means to an optical circuit of the next stage.

7. An optical apparatus for compressing an optical pulse period of an optical pulse signal, comprising:
optical delay means for delaying an input optical signal to generate a first delayed optical signal;
optical guiding means for guiding said first delayed optical signal to said optical delay means; and
optical coupling means for coupling optical signals,
wherein said optical delay means delays the first delayed optical signal to generate a second delayed optical signal, and said optical coupling means couples said second delayed optical signal with said input optical signal.

8. An apparatus according to claim 7, further comprising extracting means for extracting an optical pulse train including a predetermined number of optical pulses from an optical signal generated in said optical coupling means at a predetermined period.

9. An apparatus according to claim 7, wherein said optical delay means includes an optical fiber of a predetermined length.

10. An apparatus according to claim 7, wherein said optical guiding means includes a reflector.

11. An apparatus according to claim 7, wherein said optical coupling means includes an optical coupler.

12. A method for compressing a pulse period of an optical pulse signal of an optical apparatus having optical delay means, comprising the steps of:
delaying said optical pulse signal to generate a first delayed optical signal in said optical delay means;
guiding said first delayed optical signal to said optical delay means;
delaying said first delayed optical signal to generate a second delayed optical signal in said optical delay means; and
coupling said second delayed optical signal with said optical pulse signal.

13. A method according to claim 12, further comprising the step of extracting an optical pulse train including a predetermined number of optical pulses from an optical signal generated in the step of coupling said second delayed optical signal with said optical pulse signal.

14. A method according to claim 12, wherein an optical fiber of a predetermined length is utilized as said optical delay means.
